(19) United States
(12) Patent Application Publication
(10) Pub. No.: US 2009/0248784 A1
(43) Pub. Date: Oct. 1, 2009

(54) DISKLESS IMAGE BOOT OUTSIDE OF LAN

(75) Inventors: Richard Wayne Cheston, Morrisville, NC (US); Mark Charles Davis, Durham, NC (US); Howard Jeffrey Locker, Cary, NC (US); Rod David Waltermann, Rougemont, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 12/057,689

(22) Filed: Mar. 28, 2008

(51) Int. Cl. G06F 15/16

(52) U.S. Cl. 709/201; 709/227

(57) ABSTRACT

A local area network (LAN) server allows an authenticated user of a computer remote from the LAN to cause a diskless computer in the LAN to redirect screen shots to the computer remote from the LAN, with the screen shots being generated based on a users computer image persistently stored in an enterprise storage of the LAN.

### I. FIELD OF THE INVENTION

The present invention relates generally to diskless image boots to computers outside of a local area network (LAN) in which the image is persistently stored.

### II. BACKGROUND OF THE INVENTION

The present invention recognizes that a LAN may be provided in which diskless user computers cannot boot images (operating systems with accompanying user-tailored screen displays) from a disk onboard the user computer as ordinarily would be done, since the user computer has no disk, but instead must be booted with an image stored in the LAN apart from the user computer, to ensure standardized images across the LAN and for other control purposes. However, such booting requires relatively high bandwidth given the volume of information that must be (relatively quickly) transferred, so that should a LAN user wish to access his image from outside the LAN over typically slower links, limitations can be encountered in both booting and performance.

### SUMMARY OF THE INVENTION

A method is disclosed for permitting a computer remote from a local area network (LAN) to access a user's computer image stored in the LAN. The method includes booting a diskless computer in the LAN from an enterprise data storage in the LAN with the image. The method also includes establishing communication between the diskless computer and the computer remote from the LAN so that display information from the diskless computer can be sent to the computer remote from the LAN for display thereof and so that input signals generated by a user of the computer remote from the LAN can be received at the diskless computer.

In non-limiting embodiments secure communication is established between the diskless computer and the computer remote from the LAN. The diskless computer can be booted from the enterprise data storage using Internet Small Computer Systems Interface (iSCSI). If desired, prior to establishing communication the user of the computer remote from the LAN must first log on to a server in the LAN, with the server in the LAN informing the diskless computer of a location of the image in the enterprise data storage.

In some embodiments the method includes determining that the user is logging on to the LAN remotely based at least on an address sent from the computer remote from the LAN. Some implementations of the method can include determining whether a communication path from the LAN to the computer remote from the LAN is adequate to support a full image boot from the LAN.

In another aspect, an apparatus includes a local area network (LAN) server and a processor in the server and executing logic to allow an authenticated user of a computer remote from the LAN to cause a diskless computer in the LAN to redirect screen shots to the computer remote from the LAN, with the screen shots being generated based on a user's computer image persistently stored in an enterprise storage of the LAN.

In another aspect, a tangible computer readable medium bears instructions executable by a processor to boot a diskless computer in a local area network (LAN) from an LAN storage in the LAN with an image including an operating system. The instructions facilitate sending display information from the diskless computer to a computer remote from the LAN for display of the information on the computer remote from the LAN. The instructions also facilitate receiving input signals for the diskless computer from the computer remote from the LAN.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of one non-limiting system in accordance with present principles; and

FIG. 2 is a flow chart of one example logic that may be employed in accordance with present principles.

### DETAILED DESCRIPTION OF THE PREFERRED EMBODIMENT

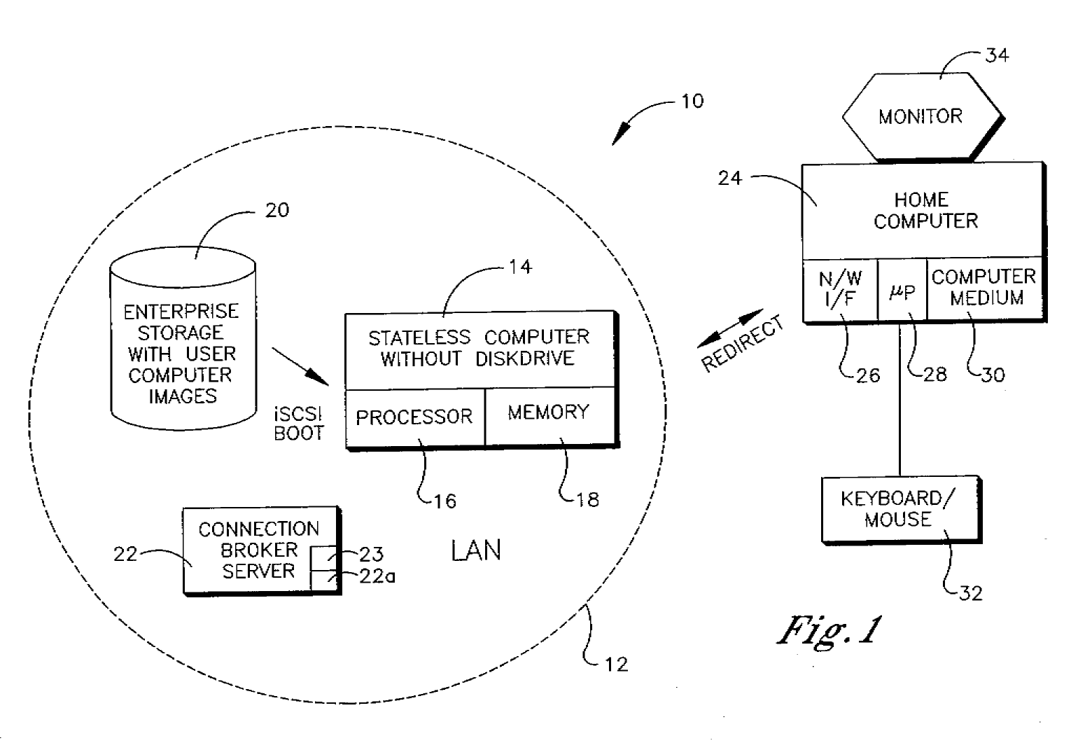

Referring initially to FIG. 1, a system is shown, generally designated 10, which includes a local area network (LAN) 12, typically an enterprise network, in which one or more stateless diskless LAN computers 14 are provided. The LAN computer 14 typically includes all components of a standard PC except a hard disk drive; thus, it includes a processor 16 and memory 18 for temporarily storing an operating system and other constituents of what is commonly referred to as an “image” during operation, with the memory 18 not representing persistent storage in that when the LAN computer 14 is deenergized, the memory 18 is cleared of data. In one example embodiment the user's image can include software supporting remote desktop access, such as remote desktop protocol (RDP).

Nevertheless the LAN computer 14 must undergo image booting when turned on and to this end an enterprise storage system 20 is provided in the LAN 14 from which an image boot such as an Internet Small Computer Systems Interface (iSCSI) boot of the LAN computer 14 may be effected by exchanging SCSI information over a transport control protocol/Internet protocol (TCP/IP) communication path within the LAN. Control of communication within the LAN 14 may be afforded by one or more connection broker servers 22 with server processor 22a and server tangible computer readable medium 23.

As intended herein, a user authenticated to use the LAN computer 14 may also be afforded access to his computer image in the storage 20 from a remotely-located home computer 24. The home computer 24 without limitation can be a notebook computer or desk top computer or any device that uses a disk drive to store data, or the home computer need not have an onboard persistent storage at all.

Whether diskless or not the home compute 24 typically includes a network interface 26 such as a modem or wireless transceiver configured for communicating with a wide area network such as the internet. The home computer 24 also has a processor 28 that can execute commands stored on a tangible computer-readable medium 30. A user may input data to the home computer 14 using an input device such as but not limited to a keyboard/mouse 32, and the processor 28 may output screen displays on, e.g., a computer monitor 34 as shown.

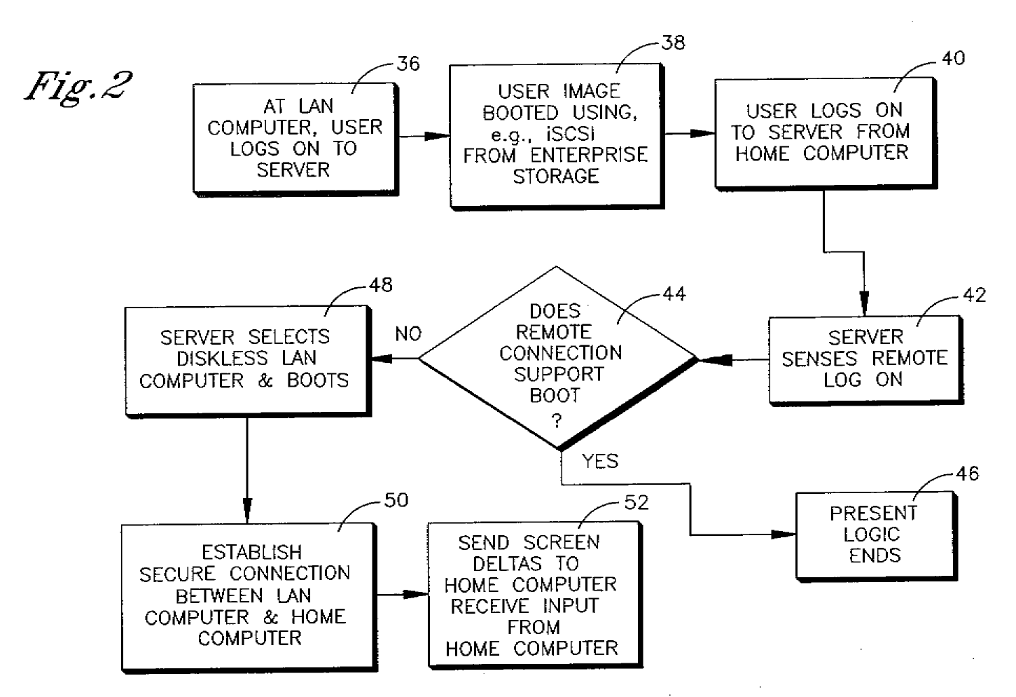

Present logic is shown in FIG. 2. The logic may be stored on one or more of the computer readable media herein for execution by one or more of the processors herein.

Commencing at block 36, at the LAN computer 14 the user logs on to the server 22, which validates the user's credentials and informs the LAN computer 14 where the user's image is stored in the enterprise storage 20. The LAN computer 14 then boots the user's image into memory 18 at block 38.

Should the user travel to a remote location such as the user's home and wish to access the LAN 14, the process moves to block 40, wherein the user manipulates the home computer 24 to log on the to the server 22 using, e.g., a virtual private network (VPN) connection. When the connection is established, the IP address of the home computer 24 and subnet information alert the server 22 at block 42 that a remote log on is being attempted. Or, as part of the log on protocol it can be indicated by the user to the server that a remote log on redirect is required.

Proceeding to decision diamond 44, the remote connection can be tested for adequacy to support a full image boot in terms of transfer and latency rates. If the connection is sufficient to support a boot the present logic may end at block 46 (doing an iSCSI boot directly from the enterprise storage to the remote computer 24), but otherwise the logic moves to block 48 wherein a flag may be set in the server 22 indicating that the computer attempting access is remote and wherein the server 22 selects from, e.g., a resource pool a diskless LAN computer such as the LAN computer 14 to execute the above-described boot (if not already done) of the LAN computer from the enterprise storage 20, informing the diskless computer of the location of the user's image in the enterprise storage.

The server 22 thus authenticates the remote user and upon successful authentication starts the LAN computer 14, informing it of where the user's image is stored in the enterprise storage. The server also sends a command or packet to the LAN computer 14 to order the LAN computer 14 to redirect screen to the remote computer as more fully set forth below. To this end, the server also provides the address of the remote computer to the LAN computer.

Moving to block 50, a connection, preferably secure, is established between the home computer 24 and the LAN computer 14. For example, the user image on the LAN computer 14 may be enabled to accept a connection certificate or to use any other secure method from the home computer 24, which is used for authentication and security purposes. At block 52, user input from the keyboard/mouse 32 is sent from the home computer 24 to the LAN computer 14 for execution thereof by the processor 16 of the LAN computer 14, while the LAN computer 14 sends to the home computer 24 information (using only screen deltas where possible) representing a screen shot generated by the LAN computer 14, for presentation thereof on the home computer 24. Changes made from the home computer to the user's image are sent from the LAN computer 14 to the enterprise storage for updating.

In this way, the user can operate the home computer 24 to cause a diskless LAN computer 14 to redirect screen shots to a secure window at the remote endpoint. This allows a properly credentialed user to log on to their image, stored in the enterprise storage 20, from any remote computer that supports, e.g., Remote Desktop Protocol (RDP) without the need for server infrastructure to support the RDP session, effectively extending use of the diskless LAN computer 14 beyond the LAN 12.

While the particular DISKLESS IMAGE BOOT OUTSIDE OF LAN is herein shown and described in detail, it is to be understood that the subject matter which is encompassed by the present invention is limited only by the claims.

What is claimed is:

1. A method for permitting a computer remote from a local area network (LAN) to access a user's computer image stored in the LAN, comprising:
booting a diskless computer in the LAN from an enterprise data storage in the LAN with the image;
establishing communication between the diskless computer and the computer remote from the LAN;
sending display information from the diskless computer to the computer remote from the LAN for display of the information on the computer remote from the LAN; and
receiving at the diskless computer input signals generated by a user of the computer remote from the LAN.

2. The method of claim 1, wherein secure communication is established between the diskless computer and the computer remote from the LAN.

3. The method of claim 1, wherein the diskless computer is booted from the enterprise data storage using Internet Small Computer Systems Interface (iSCSI).

4. The method of claim 1, wherein prior to the act of establishing communication, the user of the computer remote from the LAN must first log on to a server in the LAN, the server in the LAN informing the diskless computer of a location of the image in the enterprise data storage.

5. The method of claim 1, comprising determining that the user is logging on to the LAN remotely based at least on an address sent from the computer remote from the LAN.

6. The method of claim 1, comprising determining whether a communication path from the LAN to the computer remote from the LAN is adequate to support a full image boot from the LAN.

7. Apparatus comprising:
a local area network (LAN) server; and
a processor in the server and executing logic to allow an authenticated user of a computer remote from the LAN to cause a diskless computer in the LAN to redirect screen shots to the computer remote from the LAN, the screen shots being generated at least in part based on a user's computer image persistently stored in an enterprise storage of the LAN.

8. The apparatus of claim 7, wherein the diskless computer is booted from the enterprise storage with the image.

9. The apparatus of claim 8, wherein a secure communication path is established between the LAN and the computer remote from the LAN.

10. The apparatus of claim 9, wherein display information is sent from the diskless computer to the computer remote from the LAN for display of the information on the computer remote from the LAN and input signals generated by a user of the computer remote from the LAN are received at the diskless computer.

11. The apparatus of claim 10, wherein the diskless computer is booted from the enterprise storage using Internet Small Computer Systems Interface (iSCSI).

12. The apparatus of claim 11, wherein prior to establishing communication between the LAN and the computer remote from the LAN, the user of the computer remote from the LAN must first log on to the server.

13. The apparatus of claim 7, wherein the server determines that the user is logging onto the LAN remotely based at least on forcing a command at log on or user request at log on to indicate remote logging on.

14. The apparatus of claim 7, wherein the server determines that the user is logging on to the LAN remotely based at least on an address sent from the computer remote from the LAN.

15. The apparatus of claim 7, wherein the server determines whether the communication path is adequate to support a full image boot from the LAN.

16. The apparatus of claim 7, wherein changes to the image resulting from input from the computer remote from the LAN to the diskless computer are used to change the image in the enterprise storage.

17. A tangible computer readable medium bearing instructions executable by a processor to:
boot a diskless computer in a local area network (LAN) from an LAN storage in the LAN with an image including at least an operating system;
send display information from the diskless computer to a computer remote from the LAN for display of the information on the computer remote from the LAN; and
receive input signals for the diskless computer from the computer remote from the LAN.

18. The tangible computer readable medium of claim 17, wherein secure communication is established between the diskless computer and the computer remote from the LAN.

19. The tangible computer readable medium of claim 17, wherein the diskless computer is booted from the LAN storage using Internet Small Computer Systems Interface (iSCSI).

20. The tangible computer readable medium of claim 17, wherein prior to establishing communication, the user of the computer remote from the LAN must first log on to a server in the LAN, the server in the LAN informing the diskless computer of a location of the image.

21. The tangible computer readable medium of claim 17, wherein the instructions include determining that the user is logging on to the LAN remotely based at least on an address sent from the computer remote from the LAN.

22. The tangible computer readable medium of claim 17, wherein the instructions include determining whether a communication path from the LAN to the computer remote from the LAN is adequate to support a full image boot from the LAN.
